(19) United States
(12) Patent Application Publication
(10) Pub. No.: US 2018/0171497 A1
(43) Pub. Date: Jun. 21, 2018

(54) STRUCTURE FOR INCREASING STRENGTH AND METHOD FOR MANUFACTURING THE SAME

(71) Applicants: Seung Kyun RYU, Seoul (KR); Sook Eun BAEK, Seoul (KR)

(72) Inventors: Seung Kyun RYU, Seoul (KR); Sook Eun BAEK, Seoul (KR)

(21) Appl. No.: 15/578,891

(22) PCT Filed: Jun. 2, 2016
(86) PCT No.: PCT/KR2016/005851

§ 371 Date: Dec. 1, 2017

(30) Foreign Application Priority Data
Jun. 2, 2015 (KR) 10-2015-0078016

(51) Int. Cl. C25D 3/12; C23C 18/32; C25D 3/54; C25D 3/50; C23C 18/42

(52) U.S. Cl. CPC C25D 3/12; C23C 18/32; H04B 1/3888; C25D 3/50; C23C 18/42; C25D 3/54

(57) ABSTRACT

Disclosed herein is a structure for strengthening strength and a method of manufacturing the same, and more particularly to a structure for strengthening strength in which a coating layer made of material containing tungsten is formed on the surface of a base of a base metal or a bass of a metal base. According to the present invention, it is possible to substitute synthetic resins and metal products which are currently manufactured and used, exhibit excellent physical properties and mechanical properties as compared with those of synthetic resins and metal products. And also if necessary, the surface of the metal plating of the structure according to the present invention may be plated with various precious metals such as gold and silver to meet the demand of the customer.

### BACKGROUND

### a) Technical Field

The present invention relates to a structure for increasing strength in which a coating layer made of a material containing tungsten is formed on the surface of a nonmetal base or a metal base, and a method of manufacturing the same. More particularly, the present invention relates to a structure for strengthening tungsten to a structure for increasing strength capable of replacing a non-metallic or metal panel requiring strength, such as an electronic product case, a body of an automobile, an airplane, an airship, etc., and parts thereof, and a manufacturing method thereof.

### (b) Background Art

Recently, mobile phones have been widely used around the world, and in particular, with the development of smart phones, competition is intensifying due to the development of shape, thickness and size. The case of the conventional smartphone has been mainly made of synthetic resin (cf. Patent Document 3). Synthetic resins have been produced in large quantities because they are advantageous in terms of price and productivity. These synthetic resin cases are eco-friendly and can be coated with various kinds of metals because the coating is performed by a vacuum deposition process.

However, when the metal layer is formed through coating, it is difficult to make the thickness of the metal layer larger than a certain thickness, the coating cost is high, and a complicated shape product cannot be processed.

Because of these disadvantages, leading company A releases a metal case made of a cell phone case, and the conventional synthetic resin mobile phone is becoming less popular, and while the mobile phone made of metal case of company A is expensive, it is the most famous in the world, Market share is also high.

However, these metal cases also have problems. That is, in order to manufacture such a metallic case, a metal ingot such as aluminum ingot or aluminum magnesium alloy ingot of about 380 g is milled by a lathe to produce a case of 17 g. Some company does not manufacture these metal cases directly but assembles them from subcontractors. Subcontractor manufactures cases by installing a number of precision cutting machines. The company has a long history of accumulation of related technology it is known that it takes about 40 minutes per processing machine to produce. Other some company in Korea, a latecomer, manufactures cases by installing a number of processing machines in Vietnam to manufacture these metal cases, but it still takes much time, for example, for one case for about one hour per processing machine.

The manufacturing method of the metal case is very expensive (the highest price among actual parts cost of a mobile phone), the amount of wasted metal is great, and the manufacturing time is long. In addition, the global cell phone of the “S” company was more than 7.6 mm thick, but recent models have been thinned from 6.9 to 7.1 mm. Such a thinner cell phone is pressed with both hands or put in the back pocket of the pants, the mobile phone itself is bent, and the American, European newspapers and online news have been published the articles “New Apple is banana” or “BENDi PHONE 6”. Despite these bad reputations, consumers and markets are demanding mobile phones with metal cases. Even in such a harsh environment, it may take months to prepare an external case when a new model is released, especially when a world-wide mobile phone (WorldPhone) is introduced. It took months to prepare the case only, and it was difficult to keep secrets. However, it is a phenomenon that it cannot go back to the case of the old synthetic resin by ignoring the demand of the consumer.

In order to solve this problem, a method of die-casting an aluminum alloy is disclosed in Patent Document 1 and Patent Document 2. Such a die-casting method is cheaper than the above-mentioned method by cutting and is advantageous for mass production. It is difficult to say that it is suitable for application to the world phone because the precision is deteriorated and the esthetic feeling about the exterior is deteriorated. In order to solve these drawbacks, it is not possible to carry out the forging process itself by carrying out a process such as forging or the like on a case made of die casting, and also to make this possible, too much research is required, and it is costly and not suitable for application

### PRIOR ART LITERATURE

Patent Document 1: Korean Patent Laid Open Publication No. 10-2016-0049079

Patent Document 2: Korean Patent No, 10-0824008

Patent Document 3: Korean Patent No. 10-0690936

### BRIEF SUMMARY

In order to solve the above-mentioned problems, the mechanical strength such as tensile strength, compressive strength and the like can be increased without increasing the weight increase, and the specific strength can be increased. It is an object of the present invention to provide a technique for selecting a metal or a synthetic resin and metal plating on a surface thereof in order to provide a structural body for strength enhancement that cannot be perceived, even if the synthetic resin material is used.

In order to solve the above-mentioned problems, a synthetic resin product is selected from the group consisting of polyphenylene sulfide (PPS), polyamide and fiber reinforced resin among non-metals. And then plated in a plating bath to a thickness of 4 to 100 μm.

In this case, for the workability and durability of the coating layer, a synthetic resin product may be treated with a low-temperature plasma to introduce a hydrophilic functional group to form a coating layer.

The metal may be plated in a plating bath containing tungsten immediately on the surface of aluminum or stainless stool to a thickness of 4 to 100 μm or subjected to low temperature plasma treatment on a metal surface to form a hydrophilic functional group on the surface, and the formed metal is put into a plating hath containing tungsten and plated to a thickness of 4 to 100 μm.

As a result of studying the physical properties of the thus-prepared structure, the present inventors found that the physical properties of the resulting structure were far superior to those of the currently produced and commercially available general metal products, and that the metal-based synthetic resin material is unrecognizable in appearance from metal products, and the present invention has been completed.

### Advantageous Effects

The method for structure for increasing strength according to the present invention can replace the currently manufactured synthetic resin and metal product, and exhibits excellent physical properties compared with the physical properties of a synthetic resin or a metal product without significantly increasing its weight, mechanical strength including specific strength is greatly improved.

If necessary, the surface of the metal plating of the product according to the present invention can be plated with various precious metals such as gold and silver to meet the demands of the consumer, and also to be used in various fields such as electronic product cases, automobiles, it is an industrially useful invention such as can be applied.

### BRIEF DESCRIPTION OF THE DRAWINGS

FIG. 1 is a cross-sectional view of a strength enhancing structure according to the present invention.

FIG. 2 is a graph showing the results of simulating bending stresses of the entire aluminum electronic product case as a comparative example 1.

FIG. 3 is an enlarged view of the buttonhole portion of FIG. 2.

FIG. 4 is a graph showing the results of simulation of bending stress of the entire electronic product case made of synthetic resin as Comparative Example 2.

FIG. 5 is an enlarged view of the buttonhole portion of FIG. 4.

FIG. 6 is a graph showing a simulation result of a bending stress of an entire electronic product case made of a synthetic resin (PPS) having a nickel-tungsten coating with a thickness of 10 μm according to an embodiment of the present invention.

FIG. 7 is an enlarged view of the buttonhole portion of FIG. 6.

FIG. 8 is a graph showing the results of simulation of bonding stress of the entire electronic product case of a synthetic resin (PPS) material with a nickel-tungsten coating thickness of 20 μm according to another embodiment of the present invention.

FIG. 9 is an enlarged view of the buttonhole portion of FIG. 8.

FIG. 10 is a graph shewing the tensile strength according to the hardness of the surface plating of the synthetic resin structure according to the embodiment of the present invention.

### BEST MODES FOR CARRYING OUT THE INVENTION

The strength enhancing structure according to the present invention is characterized in that a coating layer made of a material containing tungsten is formed on the surface of a nonmetal base or a metal base.

At this time, in order to improve workability and durability of the coating layer, the non-metallic base or the surface of the metal base may be subjected to a low-temperature plasma treatment to form a hydrophilic functional group on the surface, and the coating layer may be formed on the surface of the metal or non-metal having a hydrophilic functional group formed thereon.

The non-metallic base may be selected from the group consisting of high strength polyphenylene sulfide (PPS), polyamide, fiber reinforced resin, and the metal base may be aluminum or stainless steel.

The coating layer may be mixed with a tungsten compound, a compound of nickel, cobalt, molybdenum or platinum, and may have a thickness of 4 to 100 μm.

### MODES FOR CARRYING OUT THE INVENTION

It is to be understood that both the foregoing general description and the following detailed description are exemplary and explanatory and are intended to provide further explanation of the invention as claimed. It should be understood, however, that there is no intention to limit the invention to the form just described, and the spirit and scope of the invention encompasses conventional variations, equivalents, and alternatives in the illustrated form.

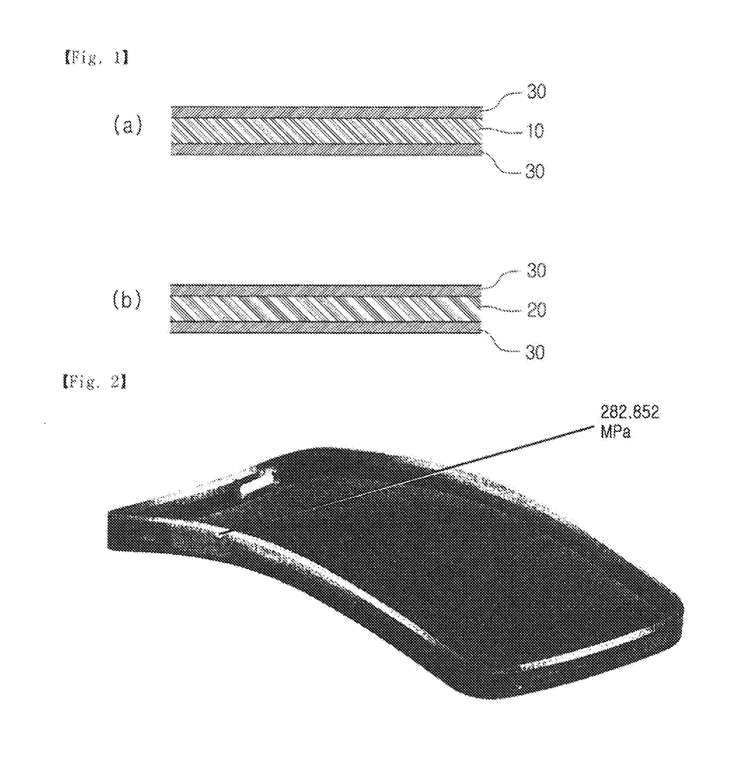

FIG. 1 is a cross-sectional view of a structure for enhancing strength according to the present invention.

As shown in FIG. 1 (a), the structure for increasing strength according to an embodiment of the present invention is a synthetic resin base 10, which is manufactured by injection molding using one or more of synthetic resin selected from a group of consisting of polyphenylene sulfide (PPS), polyamide, fiber reinforced resin, and the resulting synthetic resin base is plated with a plating bath containing tungsten to a thickness of 4 to 100 μm to form a coating layer 30.

At this time, when the coating layer 30 is formed, the synthetic resin base 10 is passed through a low temperature plasms which does not cause thermal deformation to form a hydrophilic functional group on the surface thereof in order to improve the durability while easily forming a coating layer. The coating layer 30 may be formed on the surface of the synthetic resin base.

It is known that polyphenylene sulfide (PPS), polyamide and fiber reinforced resin, which are the materials of the above-mentioned synthetic resin base 10, have excellent mechanical properties such as tensile strength and compressive strength as compared with other synthetic resin materials in the present invention, it is possible to select other synthetic resin materials that are not exemplified because their proper strength is maintained.

When the hydrophilic functional group is formed on the surface of the synthetic resin base 10 through the low temperature plasma process, the coating layer 30 containing tungsten is firmly adhered to improve the durability.

The coating layer 30 can be formed only on one side of the synthetic resin base 10 and can be formed on both sides of the synthetic resin base 10 as shown in the said FIG. and also may be formed in a form that encloses the entire surface.

It is preferable that as a material for the coating layer 30 includes a compound selected from tungsten, nickel, cobalt, molybdenum or platinum. However, the present invention is not limited to the said compound, and any material can be applied to the coating layer 30 as long as it can increase the specific strength without significantly increasing the weight but greatly increasing the strength.

The thickness of the coating layer 30 is preferably in the range of 4 to 100 μm. When the thickness of the coating layer 30 is less than 4 μm, corrosion resistance is increased. However, it is difficult to form a uniform thickness because of its thin thickness, and it is difficult to expect a strength enhancement for the purpose of the present invention. On the contrary, if the coating layer 30 is larger than 100 μm, sufficient strength can be expected, but since it takes a long time in the process, it is not economical because the productivity is poor. Therefore, the thickness can be appropriately selected in the range of 4 to 100 μm.

As referred to FIG. 1(b ), the strength enhancing structure according to another embodiment of the present invention is formed by plating a metal base 20 made of aluminum or stainless steel to a thickness of 4 to 100 μm in a plating bath containing tungsten to form a coating layer 30 on the surface.

It is possible to form a coating layer containing tungsten directly on the surface of the metal base 20 without any additional treatment process. However, in order to facilitate the plating process and durability of the coating layer, the surface of the metal base 20 is subjected to low temperature plasma treatment to form a hydrophilic functional group, and, it is also conceivable to form the coating layer 30 containing tungsten on the surface of the metal base 20 on which the hydrophilic functional group is formed.

The coating layer 30 may be formed on only one side of the metal base 20, out may be formed on both sides as shown in the figure or may be formed to surround the entire surface of the metal base 20,

The coating layer 30 may be a mixture of a tungsten compound and a compound of nickel, cobalt, molybdenum or platinum as described above. In this case, the material of the coating layer 30 may be other materials net exemplified so long as it can increase the specific strength as intended by the present invention. In consideration of the object of the present invention end workability, the thickness of the coating layer 30 is 4 to 100 μm.

In order to compare the strength of the plate having coating layer 30 with that of the non-coating layer, a bending test was carried out as fellows.

The synthetic resin base 10 of the present invention was formed into an electronic product case, say, cellular phone case, and then a nickel-tungsten coating layer 30 was formed on the surface thereof. And as the comparative material, an electronic product case made of an aluminum case without coating was used. A bending test was performed using an ANSYS simulation program to investigate the stress acting on each of the above products.

In the test method, stress acting on each part was measured under the condition of bending with a force of 100 N on both sides in a state where a support was provided at the center in the longitudinal direction of a uniform cell phone case with a thickness of 1.5 mm. The simulation results are shown in FIGS. 1 to 8.

### Comparative Example 1

### Bending of Electronic Product Case of Aluminum Material

FIG. 2 is a view showing a simulation result of a bending stress of an entire aluminum case of an uncoated electronic product, and FIG. 3 is an enlaced view of the buttonhole portion of FIG. 2.

Referring to FIG. 2 and FIG. 3, when an electronic product case made of an aluminum material is bent, stress is mainly concentrated on both edges of the central portion in the longitudinal direction. In particular, the maximum stress of about 282.9 MPa was concentrated in the portion where the buttonhole was formed, which means that the structure of the hole portion of the electronic product case is weakened to easily break when bending.

### Comparative Example 2

### Bending of Electronic Product Case of Synthetic Resin (PPS) Material

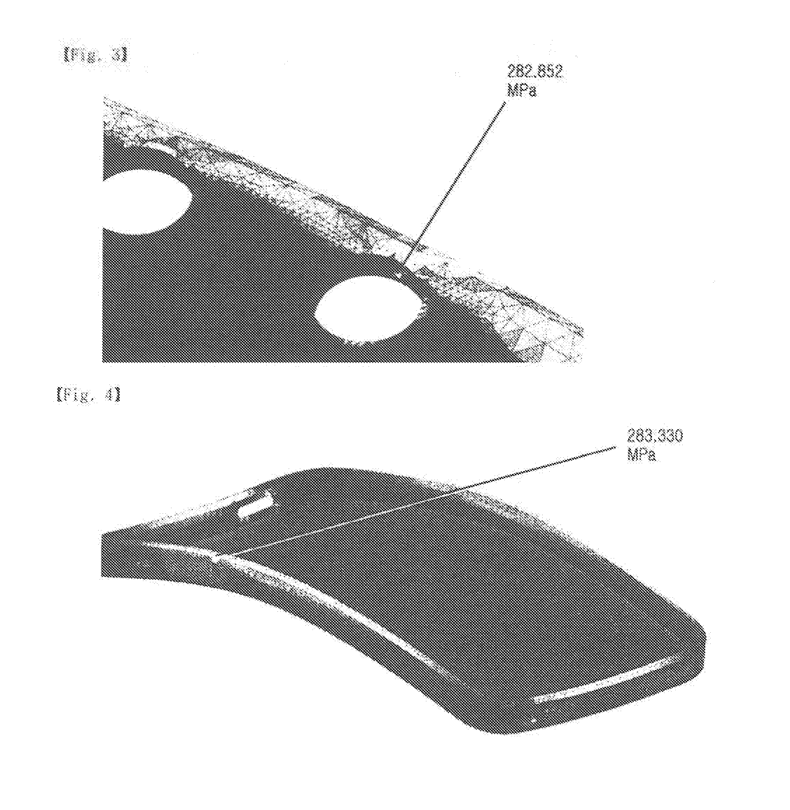

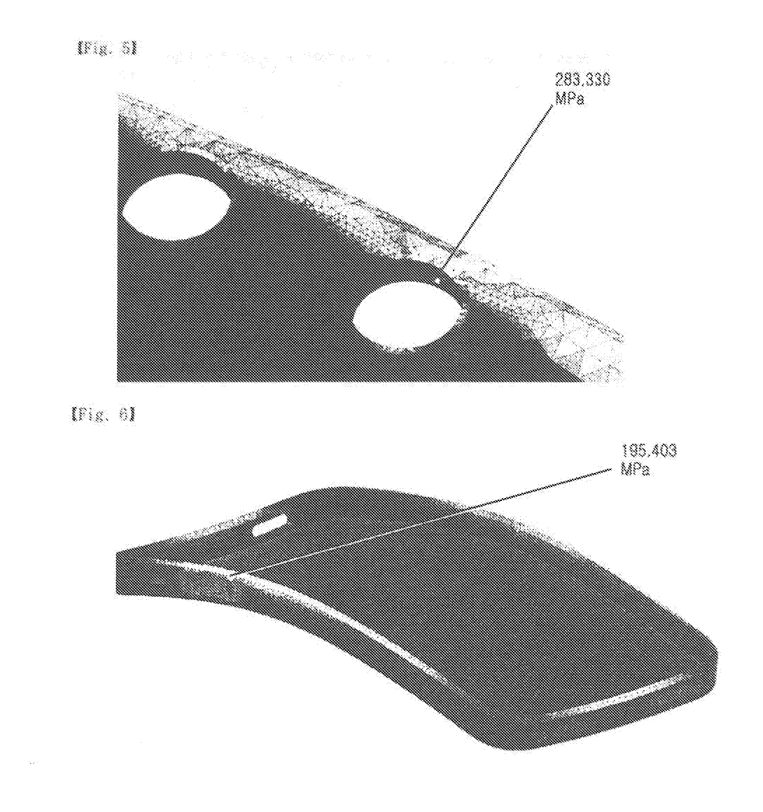

FIG. 4 is a graph showing the results of simulation of the bending stress of the entire electronic product case of a common synthetic rosin (PP) without coating, and FIG. 5 is an enlarged view of the buttonhole portion of FIG. 4.

Referring to FIGS. 4 and 5, when a case made of a synthetic resin material was bent, the stress concentrated mainly on both sides of the center portion in the longitudinal direction. In particular, the maximum stress of about 283.3 MPa was concentrated at the portion where the buttonhole was formed, which was similar to the bending simulation result of the aluminum material described as in above. This means that the structure of the portion where the buttonhole is perforated in the electronic product case is weak, so that it can be easily broken when bending.

### Test Example 1

### Bending of the Synthetic Resin Structure Having the Nickel-Tungsten Coating Layer of 10 μm Thickness According to an Embodiment of the Present Invention

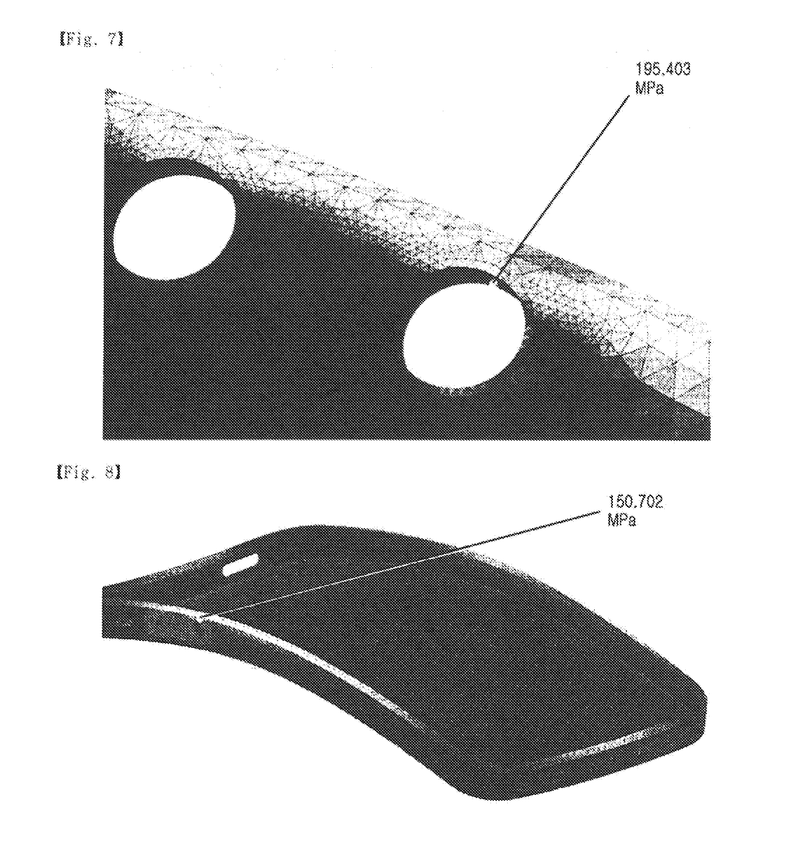

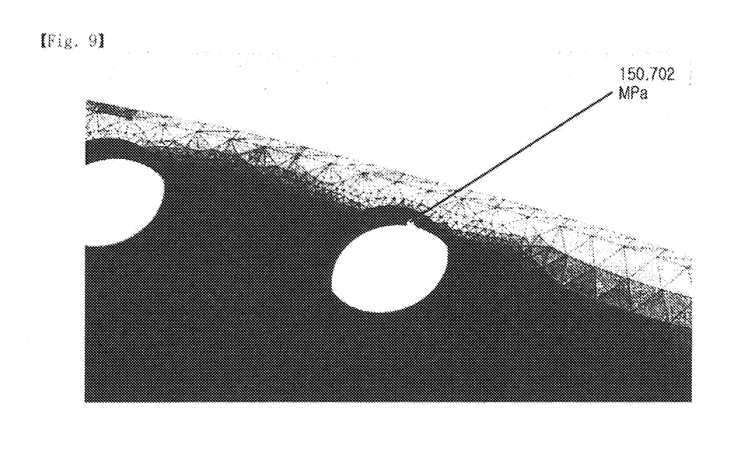

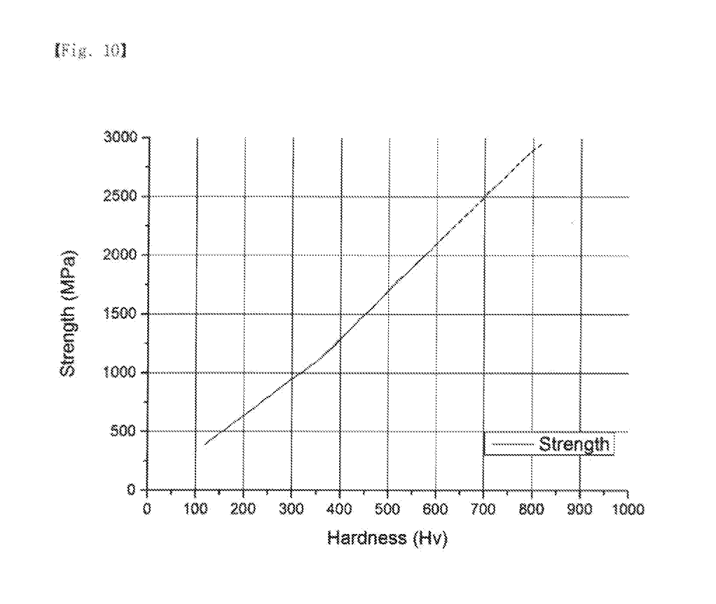

FIG. 6 is a graph showing a simulation result of a bending stress of the entire electronic product case, which is a nickel-tungsten-coated synthetic resin (PPS) structure according to an embodiment of the present invention. FIG. 7 is an enlarged view of the buttonhole portion of FIG. 8.

Referring to FIGS. 6 and 7, when a nickel-tungsten coating was uniformly coated on the surface of an electronic product case made of a synthetic resin material with a thickness of 10 μm, stress was concentrated on both edges of the center portion in the longitudinal direction of the electronic product case, and the maximum stress was about 195.4 MPa at the portion where the buttonhole was mainly formed.

The maximum stress of the hole portion when the nickel-tungsten coating was applied to a thickness of 10 μm as described shove was reduced to about 88 MPa compared with the maximum stress of the aluminum case (Comparative Example ) and the maximum stress of the synthetic resin case (Comparative Example 2), which means that the stress was prevented from concentrating on a specific portion as the total strength increases.

### Test Example 2

### Bending of the Synthetic Resin Structure Having the Nickel-Tungsten Coating Layer of 20 μm Thickness According to Another Embodiment of the Present Invention

FIG. 6 is a graph showing a simulation result of a bending stress of the whole electronic product case, which is a nickel-tungsten-coated synthetic resin (PPS) structure having a thickness of 10 μm according to an embodiment of the present invention.

Referring to 6 and 7, when a nickel-tungsten coating was uniformly coated on the surface of an electronic product case made of a synthetic resin material and uniformly coated with a thickness of 10 μm, stress was concentrated on both edges of the center portion in the longitudinal direction of the electronic product case, and the maximum stress was about 195.4 MPa at the portion where the buttonhole was mainly formed.

The maximum stress of the hole portion when the nickel-tungsten coating was applied to a thickness of 10 μm as described above was reduced to about 88 MPa compared with the maximum stress of the aluminum case (Comparative Example 1) and the maximum stress of the synthetic resin case (Comparative Example 2), which means that the stress concentration was prevented from concentrating on a specific portion as the total strength increases.

### Test Example 2

### Bending of the Synthetic Resin Structure Forming the Nickel-Tungsten Coating Layer of 20 μm Thickness According to Another Embodiment of the Present Invention

FIG. 8 is a graph showing the results of simulation of the bending stress of the whole electronic product case, which is a structure of a nickel-tungsten-coated synthetic resin (PPS) material according to another embodiment of the present invention.

Referring to 8 and 9, when a nickel-tungsten coating was uniformly coated on the surface of an electronic product case made of a synthetic resin material and uniformly coated with a thickness of 20 μm, stress was concentrated on both edges of the center portion in the longitudinal direction of the electronic device case, and the maximum stress at the portion where the buttonhole was mainly formed was about 150.7 MPa.

When the nickel-tungsten coating was applied to a thickness of 20 μm, the maximum stress of the hole portion was reduced to about 133 MPa as compared with the maximum stress of the aluminum case (Comparative Example 1) and the maximum stress of the synthetic resin case (Comparative Example 2), which means that the stress concentration was prevented from concentrating on a specific portion as the total strength was increased and also the strength is superior to that of Test Example 1.

In view of the results of these comparative examples and test examples, as in the present invention, when a nickel-tungsten coating layer is formed on a synthetic resin base, it is possible to prevent the stress from concentrating on a specific portion. As the thickness of the coating layer becomes thicker, the stress concentration phenomenon decreases more greatly and the overall strength increases.

Therefore, the structure for increasing strength of the present invention can replace the conventional case of an electronic product case made of a synthetic resin material or of an aluminum material. Further, even when applied to a synthetic resin and an aluminum structure, the strength is increased and the durability against bending is improved.

Further, according to the results of Comparative Example 1 and Comparative Example 2, considering that the maximum stresses of aluminum and synthetic resin cases are similar to each other, the strength can be increased even when the nickel-tungsten coating layer is formed on the case surface of the aluminum material as in the present invention.

FIG. 10 is a graph showing the tensile strength according to the hardness of the surface plating of the strength enhancing structure according to the embodiment of the present invention.

The Vickers hardness (Hv) of the nickel-tungsten plated layer of the strength enhancing structure of the present invention was measured to be 650 to 700.

The graph of the dashed line in FIG. 10 is derived by extrapolating the tensile strength from 600 to 650 Hv in the graph based on the published hardness conversion table (see Table 1 below). According to this, it can be deduced that the tensile strength of the coating layer is about 2226 to 2500 MPa.

TABLE 1

| Vickers hardness | Shore hardness | The tensile strength (MPa) |
|---|---|---|
| (Hv) | (Hs) | (approximate) |
| 900 | 95 | (3000) |
| 800 | 88 | (2800) |
| 700 | 81 | (2500) |
| 650 | 76 | (2225) |
| 600 | 74 | 2075 |
| 550 | 70 | 1915 |
| 500 | 66 | 1695 |

Thus, the structure for increasing strength of the present invention is increased to about 2225 to 2500 MPa in comparison with the specific gravity increment by the coating layer, and this rise represents an excellent tensile strength of the structure.

### Test Example 3

### Bending Stress Test According to Coating Layer Thickness (1)

A test piece having a coating layer formed on a metal end a non-metal material using a plating solution of electroless plating in a plating solution of 90° C. was tested for bending stress with a test piece on which no coating layer was formed, and the results are shown in Table 2 below.

Each specimen is 100 mm in width, 20 mm in length and 2 mm in thickness, but the thickness of embossed SUS is 1 nm.

TABLE 2

| | Bending stress (kg) | | | |
|---|---|---|---|---|
| Plating Thickness | embossed | | | |
| (μm) | SUS | ABS | PC | PPS |
| 0 | 13.151 | 3.50 | 5.15 | 8.04 |
| 4 | — | 3.49 | 5.55 | 9.252 |
| (Plating liquid | | | (7.7%) | (15%) |
| tempature: 90° C.) | | | | |
| 8 | 14.32 | 3.60 | 5.65 | 9.45 |
| (Plating liquid | (8.8%) | (2.8%) | (9.7%) | (17.5%) |
| tempature: 90° C.) | | | | |
| Specific gravity | 7.93 | 1.07 | 1.19 | 1.35 |
| Increase in specific | 0.147 | | — | 1.04 |
| strength | | | | |
| Remarks | | Plating has | Small | No ther- |
| | | large thermal | heat de- | mal de- |
| | | deformation | formation | formation |

As shown in Table 2, ABS and PC, which have low heat resistance temperature when plated with a non-electrolytic plating solution in a 90° C. plating solution, did not show a large Increase in strength due to plating due to thermal deformation during plating. However, PPS with excellent heat resistance showed no significant thermal deformation and increased strength significantly.

The increase of the specific strength was 7.07 times higher than that of SUS. The increase of the specific strength by the coating layer was more effective for light metal or synthetic resin than for heavy metal.

### Test Example 4

### Bending Stress Test According to Coating Layer Thickness (2)

A test piece having a coating layer formed on an SUS plate and a PPS plate using an electroplating method was prepared, and a bending stress was tested together with a test piece on which no coating layer was formed. The results are shown in Table 3 below.

The size of each test piece is 100 mm in width, 20 mm in length and 2 mm in thickness.

TABLE 3

| | | SUS | PPS | |
|---|---|---|---|---|
| | | Bending | Bending | |
| | | stress | stress | |
| | | (kg) | (kg) | Remarks |
| Plating | 0 | 13.151 | 8.040 | Based on 100 μm |
| Thickness | | (0) | (0) | coating, the specific |
| (μm) | | | | strength of lightweight |
| | | | | PPS is about 4 times |
| | | | | larger than that of |
| | | | | SUS, and the specific |
| | | | | strength increase is |
| | | | | about 6 times larger |
| | 15 | 14.636 | 9.528 | |
| | 30 | 14.939 | 9.828 | |
| | 40 | 15.078 | 9.967 | |
| | 60 | 15.094 | 9.983 | |
| | 80 | 16.129 | 11.018 | |
| | 100 | 16.193 | 11.087 | |
| Specific gravity | | 7.93 | 1.35 | |
| Specific | Before | 1.658 | 5.95 | |
| strength | coating | | | |
| | After coating | 2.04 | 8.21 | |
| | (100 μm) | | | |

| | | |
|---|---|---|
| specific strength increase | 0.382 | 2.28 |

As shown in Table 3, when the coating layer was formed on each of SUS and PPS, the bending stress was increased and the specific strength was increased as the thickness was increase. Specific strength also was increased in both SUS and PPS, but the strength of PPS having light weight is larger than that of SUS, which is relatively heavy.

Especially, the increase of specific strength was about 497% higher than that of SUS, and the specific strength increase effect was more effective for non-metals with relatively low specific gravity.

While the present invention has been particularly shown and described with reference to exemplary embodiments thereof, it is to be understood that the invention is not limited to the disclosed exemplary embodiments or constructions. It will be understood by those skilled in the art that various changes in form and details may be made therein without departing from the spirit and scope of the invention as defined in the appended claims.

What is claimed is:

1. The structure tor increasing strength comprises a coating layer made of a material containing tungsten on the surface of a nonrnetal base or a metal base.

2. The structure for increasing strength according to claim 1, wherein the coating layer is one obtained by forming the hydrophilic functional group on the surface of the metal or base metal, subjecting to low-temperature plasma treatment, and then subjecting to coating treatment on the non-metallic base or the metal base surface.

3. The structure for increasing strength according to claim 1, wherein the non-metallic base is selected from the group consisting of polyphenylene sulfide (PPS), polyamide, and fiber reinforced resin.

4. The structure for increasing strength according to claim 1, wherein the metal base is aluminum or stainless steel.

5. The structure for increasing strength according to claim 1, wherein the coating layer is formed of a tungsten compound and a compound selected from a group of nickel, cobalt, molybdenum or platinum, and has a thickness of 4 to 100 μm.
